(19) United States
(12) Patent Application Publication
(10) Pub. No.: US 2021/0180679 A1
(43) Pub. Date: Jun. 17, 2021

(54) CASE

(71) Applicant: JATCO LTD, Fuji-shi, Shizuoka (JP)

(72) Inventors: Atsushi KIMURA, Ayase, Kanagawa (JP); Yoshie ARAKAWA, Hiratsuka, Kanagawa (JP)

(21) Appl. No.: 17/054,297

(22) PCT Filed: May 22, 2019
(86) PCT No.: PCT/JP2019/020211

§ 371 Date: Nov. 10, 2020

(30) Foreign Application Priority Data
Jun. 8, 2018 (JP) 2018-110618

(51) Int. Cl. F16H 57/032; C22C 23/00; F16H 57/04

(52) U.S. Cl. CPC F16H 57/032; F16H 2057/02043; F16H 57/041; C22C 23/00

(57) ABSTRACT

A case includes a main body made of a magnesium alloy, and configured to house oil therein. An inner wall surface of the main body is coated with a black film.

This is a U.S. national phase application of PCT/JP2019/020211, filed on May 22, 2019, which claims priority to Japanese Patent Application No. 2018-110618, filed on Jun. 8, 2018. The entire disclosure of Japanese Patent Application No. 2018-110618 is hereby incorporated herein by reference.

### TECHNICAL FIELD

The present invention relates to a case.

### BACKGROUND ART

With an automatic transmission for a vehicle, using a magnesium alloy for the material of the components to reduce weight is known. In Japanese Laid-Open Patent Publication No. 2010-90405, it is disclosed that a transmission case (one of the cases) can be considered as one application of a magnesium alloy.

### SUMMARY

When the inventors did trial production of a case made of a magnesium alloy, they discovered that the inner wall surface of the case turned black with a mottled appearance. The mottled black state had a poor appearance, and there was concern that it would give a disagreeable feeling to the delivery recipient.

In light of that, the purpose of the present invention is to provide a case that does not give a disagreeable feeling to the delivery recipient.

One aspect of the present invention is a case made of a magnesium alloy in which oil is housed in the interior, wherein the inner wall surface of the case is a coated region on which a black film is formed.

According to the present invention, it is possible to provide a case for which the appearance of the case is improved, and that does not give a disagreeable feeling to the delivery recipient.

### BRIEF DESCRIPTION OF THE DRAWINGS

FIG. 1 is a drawing for explaining an automatic transmission case.

FIG. 2 is a drawing for explaining the automatic transmission case.

FIG. 3 is a drawing for explaining a transmission case.

FIG. 4 is a drawing for explaining a coating of the transmission case.

FIG. 5 is a drawing for explaining the transmission case.

FIG. 6 is a drawing for explaining the transmission case of a modification example.

### DETAILED DESCRIPTION OF EMBODIMENTS

Following, a mode for carrying out the invention is explained using an automatic transmission case 4 for a vehicle, that includes a transmission case 1 (an example of a case including a main body), as an example.

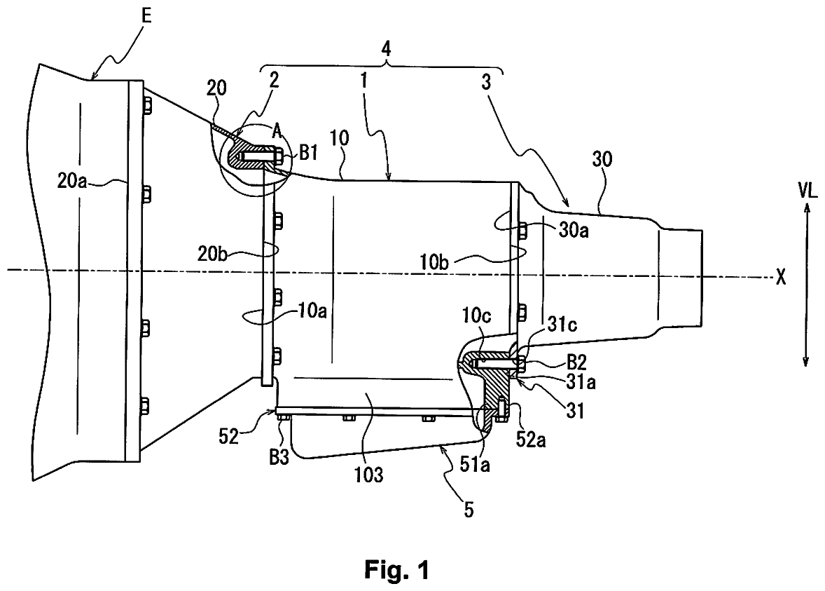

FIG. 1 is a schematic diagram for explaining the automatic transmission case 4.

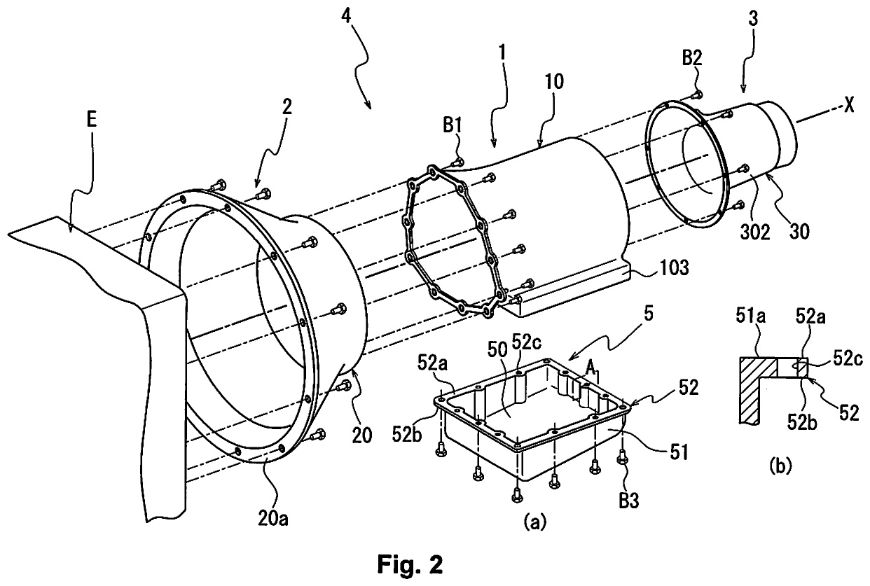

FIG. 2 is a schematic diagram for explaining the automatic transmission case 4. FIG. (a) is an exploded perspective view of the automatic transmission case 4. FIG. (b) is a drawing showing a cross section of an oil pan 5 cut at surface A in FIG. (a).

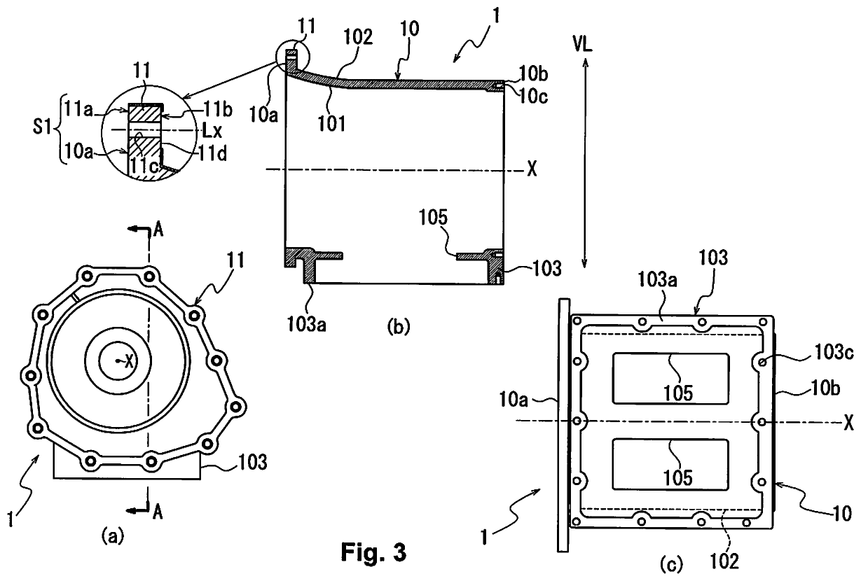

FIG. 3 is a schematic diagram for explaining the transmission case 1. FIG. (a) is a drawing of the transmission case 1 in FIG. 2 seen from a converter housing 2 side. FIG. (b) is an A-A cross section view of the transmission case 1 in FIG. (a). FIG. (c) is a drawing of the transmission case 1 in FIG. 2 seen from the oil pan 5 side.

For convenience of the explanation, for the connection of the transmission case 1 and the converter housing 2, a case is explained of screwing in a bolt B1 facing the converter housing 2 from the transmission case 1 side.

As shown in FIGS. 1 and 2, the automatic transmission case 4 is configured from the transmission case 1 that houses a transmission (not illustrated) and a control valve unit (not illustrated), converter housing 2 that houses a torque converter (not illustrated), and a reduction case 3 that houses an output shaft (not illustrated).

Also, using the installation state of the automatic transmission case 4 in FIG. 1 as a reference, the oil pan 5 that stores a lubricating oil OL is fixed to the bottom part of the transmission case 1 in a vertical line VL direction (in the drawing, the vertical direction).

The transmission (transmission mechanism) housed inside the transmission case 1 has a plurality of rotating bodies, and a plurality of friction engagement elements (clutch, brake).

These plurality of rotating bodies and plurality of friction engagement elements are provided along a rotation axis X, and with the transmission, by changing the engage/release combination of the plurality of friction engagement elements, the transmission route of the rotation drive force is switched, realizing the desired gear ratio.

On one end of the transmission case 1 in the rotation axis X direction (left end in FIG. 1), the converter housing 2 is joined from the rotation axis X direction, and is fixed by a bolt. On the other end of the transmission case 1 in the rotation axis X direction (right end in FIG. 1), the reduction case 3 is joined from the rotation axis X direction, and is fixed by a bolt.

The oil pan 5 blocks a bottom opening of the transmission case 1, and the lubricating oil OL used for friction engagement element operation and rotating body lubrication is made to return to inside the oil pan 5 through the bottom opening of the transmission case 1.

### Transmission Case 1

As shown in FIGS. 1 and 2, the transmission case 1 has a substantially cylindrical base 10. With the transmission case 1, the center line of the base 10 and the rotation axis X of the transmission are matched. A one end surface 10a (end surface 10a at the left side in FIG. 1) of the base 10 in the rotation axis X direction is a flat surface orthogonal to the rotation axis X.

As shown in FIGS. 3 (a) and (b), a flange part 11 is formed on the one end surface 10a side of the base 10. The flange part 11 extends from a cylindrical outer wall surface 102 of the base 10 in the direction separating from the base 10 in the radial direction of the rotation axis X. The flange part 11 is provided across the entire circumference of the base 10 in the circumferential direction around the rotation axis X.

A through hole 11c penetrates the flange part 11 in the rotation axis X direction. The through hole 11c penetrates between one side surface 11a (side surface 11a in the left side of FIG. 3 (b)) of the flange part 11 in the rotation axis X direction and the other side surface 11b (side surface 11b in the right side of FIG. 3 (b)). A plurality of the through holes 11c are provided in the circumferential direction around the rotation axis X (see FIG. 3 (a)). A center line Lx of the through hole 11c is parallel to the rotation axis X.

Here, when there are two components (or members), a mating surface is formed by adhering a first surface having a first component to a second surface having a second component. In this case, the first surface is the mating surface region in the first component, and the second surface is the mating surface region in the second component.

The one side surface 11a of the flange part 11 is provided to form the same plane as the one end surface 10a of the base 10. The one side surface 11a of the flange part 11 and the one end surface 10a of the base 10 become a mating surface region S1 with the converter housing 2 described later.

A bearing surface 11d in a prescribed range around the through hole 11c is formed on the other side surface 11b of the flange part 11.

As shown in FIGS. 3 (a) and (b), the other end surface 10b (end surface 10b of the right side in FIG. 1) of the base 10 in the rotation axis X direction is a flat surface orthogonal to the rotation axis X. A bolt hole 10c is formed on the other end surface 10b of the base 10. The bolt hole 10c is provided facing along the rotation axis X, and a plurality are provided with a gap open in the circumferential direction around the rotation axis X (see FIG. 2). The other end surface 10b becomes the mating surface region with the reduction case 3 described later (with the explanation hereafter, the other end surface 10b is also noted as the mating surface region 10b).

With the installation state of the automatic transmission case 4 in FIG. 1 as a reference, a wall part 103 is provided on the bottom part of the base 10 in the vertical line VL direction.

As shown in FIGS. 3 (a) and (c), the wall 103 extends in the direction separating from the base 10 along the vertical line VL direction, and also surrounds the bottom opening of the base 10 around the entire circumference (see FIG. 3 (c)).

Also, an opening 105 that connects the interior and exterior of the base 10 is formed in the region surrounded by the wall 103 in the base 10.

Viewing from below the base 10, the opening 105 is formed inside the region surrounded by the wall 103.

A bottom end surface 103a of the wall 103 is a flat surface orthogonal to the vertical line VL. A plurality of bolt holes 103c are formed on the bottom end surface 103a. The bolt holes 103c are provided facing along the vertical line VL. The bottom end surface 103a becomes the mating surface region with the oil pan 5 described later (in the explanation hereafter, the bottom end surface 103a is also noted as the mating surface region 103a).

Details will be noted later, but with the transmission case 1, except for prescribed regions such as mating surface regions S1, 10b, 103a, etc., a coating C of magnesium hydroxide (Mg(OH)₂) is formed on the entire surface of the base 10 (inner wall surface 101, outer wall surface 102).

### Converter Housing 2

As shown in FIGS. 1 and 2, the converter housing 2 has a substantially cylindrical base 20. The converter housing 2 is placed in a state with the center line of the base 20 matched to the rotation axis X. One end surface 20a (end surface 20a of the left side in FIG. 1) of the base 20 and another end surface 20b (end surface 20b of the right side in FIG. 1) in the rotation axis X direction are a flat surface orthogonal to the rotation axis X.

The one end surface 20a of the base 20 is connected to an engine side fixing member E with the engine (not illustrated) housed inside (end surface 20a of the left side of the base 20 in FIG. 1). In this case, the end surface 20a is the mating surface region that is adhered to the engine side fixing member E.

The other end surface 20b of the base 20 is connected to the transmission case 1 (end surface 20b of the right side of the base 20 in FIG. 1). In this case, the other end surface 20b becomes the mating surface region that is adhered to the mating surface region S1 of the transmission case 1 noted above.

A bolt hole 20c is formed in the rotation axis X direction on the other end surface 20b. The bolt hole 20c is provided at a position corresponding one-to-one with the abovementioned through hole 11c formed on the flange part 11 in the circumferential direction around the rotation axis X.

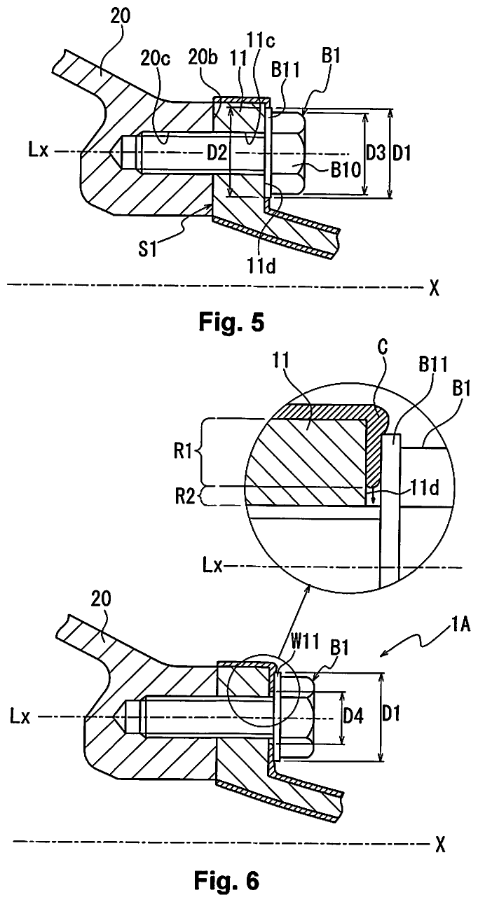

The transmission case 1 and the converter housing 2 are fixed with a bolt B1 that passes through the through hole 11c and the bolt hole 20c interposed (see FIG. 5). By the fastening force of the bolt B1, the transmission case 1 is adhered with the converter housing 2 at the mating surface region S1 along the entire circumference around the rotation axis X.

### Reduction Case 3

As shown in FIGS. 1 and 2, the reduction case 3 has a substantially cylindrical base 30. The reduction case 3 is placed in a state with the center line of the base 30 matched to the rotation axis X. One end surface 30a (end surface 30a of the left side in FIG. 1) of the base 30 in the rotation axis X direction is a flat surface orthogonal to the rotation axis X.

At the one end surface 30a side of the base 30, a flange part 31 is formed. The flange part 31 extends from a cylindrical outer wall surface 302 of the base 30 in the direction separating from the base 30 in the radial direction of the rotation axis X. The flange part 31 is provided across the entire circumference of the base 30 in the circumferential direction around the rotation axis X.

A through hole 31c penetrates the flange part 31 in the rotation axis X direction. The through hole 31c penetrates between one side surface 31a and the other side surface 31b of the flange part 31 in the rotation axis X direction. The through hole 31c is provided at a position corresponding one-to-one to the bolt hole 10c formed on the other end surface 10b of the abovementioned base 10.

The one side surface 31a of the flange part 31 is provided to form the same plane as the one end surface 30a of the base 30. The one end surface 30a of the base 30 and the other side surface 31a of the flange part 31 become a mating surface region that is adhered to the mating surface region 10b of the transmission case 1.

The transmission case 1 and the reduction case 3 are fixed with interposition of a bolt B2 that passes through the bolt hole 10c and the through hole 31c. By the fastening force of the bolt B2, the transmission case 1 is adhered to the reduction case 3 along the entire circumference around the rotation axis X at the mating surface region 10b.

### Oil Pan 5

As shown in FIGS. 1 and 2, the oil pan 5 has a substantially rectangular bottom wall 50 in the plan view, and a peripheral wall 51 that surrounds the peripheral edge of the bottom wall 50 along the entire circumference. On an end surface 51a of the side opposite to the bottom wall 50 of the peripheral wall 51 in the vertical line VL direction, a flange part 52 is formed. The flange part 52 is formed across the entire circumference along the outer peripheral edge of the peripheral wall 51. A through hole 52c penetrates the flange part 52 in the vertical line VL direction. The through hole 52c penetrates between one side surface 52a and another side surface 52b of the flange part 52 in the vertical line VL. The end surface 51a of the peripheral wall 51 is a flat surface orthogonal to the vertical line VL. The one side surface 52a of the flange part 52 is provided to form the same plane as the end surface 51a of the peripheral wall 51.

The through hole 52c is provided at a position corresponding one-to-one with the bolt hole 103c formed on the wall 103 of the abovementioned base 10.

The one side surface 52a of the flange part 52 forms the mating surface region that adheres to the mating surface region 103a of the transmission case 1.

The transmission case 1 and the oil pan 5 are fixed with interposition of a bolt B3 that passes through the bolt hole 103c and the through hole 52c. By the fastening force of the bolt B3, the transmission case 1 is adhered to the oil pan 5 along the entire circumference around the vertical line VL at the mating surface region 103a.

Here, when the constitutional elements of the automatic transmission case 4 (transmission case 1, converter housing 2, reduction case 3) and the oil pan 5 are produced using an alloy containing magnesium, the inner peripheral surface of each of these constitutional elements and the inner peripheral surface of the oil pan 5 are blackened with a mottled appearance.

The inventors considered as follows the cause of blackening with a mottled appearance. With the explanation hereafter, the transmission case 1 is explained as an example.

Magnesium alloys are highly reactive. A chemical reaction is caused when a magnesium alloy contacts water (H₂O). On the surface of the magnesium alloy in the part that contacted water, a black coating of magnesium hydroxide (Mg(OH)₂) is formed.

On the inside of the transmission case 1, the lubricating oil OL used for lubrication of the rotating body or operation of the friction engaging elements moves along the inner circumference of the transmission case 1 to the oil pan 5 side.

Here, the lubricating oil OL contains moisture, so when the lubricating oil OL moves along the inner circumference of the case, the moisture within the lubricating oil OL reacts with the magnesium alloy that configures the transmission case 1, and a coating of magnesium hydroxide is formed on the inner wall surface 101 of the transmission case 1.

Also, the lubricating oil OL is not in even contact with the entire region of the inner wall surface 101. For example, the lubricating oil scraped up by the rotating body is in contact with substantially the same region of the inner wall surface 101. Also, the lubricating oil OL that contacted the inner wall surface 101 moves to the oil pan 5 side through substantially the same path of the inner wall surface 101.

For that reason, with the inner wall surface 101, as a result of the occurrence of areas that frequently contact the lubricating oil OL and areas that do not frequently contact it, the coating on the inner wall surface 101 is generated with a mottled appearance.

Having done that, with areas at which the coating is generated to be thick and looks dark and areas where it is not generated to be thick, the shading differs, so when looking at the inner wall surface 101, the presence and absence of the coating gives a mottled pattern, resulting in a poor appearance.

In light of that, the inventors decided to prevent having a poor appearance by providing the coating C of magnesium hydroxide in advance on the entire surface of the transmission case 1.

### Coating C

The coating C of the transmission case 1 is explained.

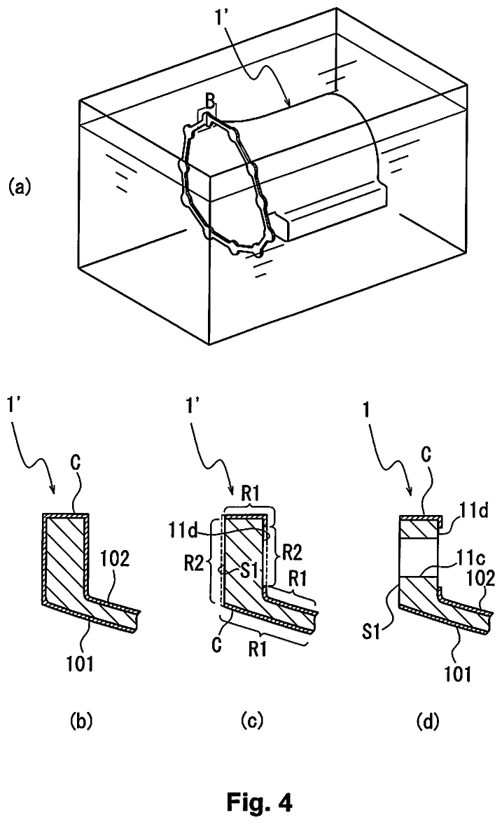

FIG. 4 is a drawing for explaining the coating C of the transmission case 1. FIG. (a) is a drawing for explaining formation of the coating C, and shows a transmission case 1′ as a raw material. FIG. (b) is a drawing showing a cross section with the transmission case 1′ cut at surface B in FIG. (a). FIG. (c) is a drawing for explaining the mating surface region S1 and the bearing surface 11d. FIG. (d) is a drawing for explaining the transmission case 1 as a product. The thickness of the coating C is shown exaggerated.

The transmission case 1 of the embodiment is produced by implementing a prescribed machining after forming the coating C of magnesium hydroxide on the entire surface (including the inner wall surface 101 and the outer wall surface 102) of the transmission case 1′ as the raw material. The transmission case 1′ as the raw material is molded by casting.

As shown in FIG. 4 (a), formation of the coating C is performed by immersing the entire transmission case 1′ in a container filled with water, for example.

When the transmission case 1′ is immersed, the entire surface of the transmission case 1′ is in contact with water. Then, the magnesium alloy and water chemically react. By doing this, the coating C of magnesium hydroxide is formed on the entire surface of the transmission case 1′ (see FIG. 4 (b)).

Because magnesium hydroxide is black, the transmission case 1′ has the entire surface change color to black.

The entire transmission case 1′ does not have to be immersed. For example, it is also possible to form the coating C on the desired area of the transmission case 1′ by applying water using a hose, etc. As noted previously, by water that has mixed in the lubricating oil OL, of the surface of the transmission case 1, the inner wall surface 101 side is the part that has a mottled appearance. Therefore, it is possible to apply water to the inner wall surface 101 and form the coating C only on the inner wall surface 101 to be black.

In this case, it is not absolutely necessary for the coating C to be formed on the entire surface (100%) of the inner wall surface 101, and a slight peeling or scraping, etc., is allowed. In other words, the entire surface of the inner wall surface 101 is sufficient provided the area for which the entire inner wall surface 101 can be recognized as being black when seen by a human (90% or greater, preferably 95% or greater, more preferably 98% or more of the surface area) is black.

Also, before forming the coating C, it is preferable to perform the process of removing impurities generated on the surface of the transmission case 1′ using a shot blasting process, etc.

For example, at the casting stage, there are cases of impurities being generated on the surface of the transmission case 1′. Contact of the surface of the transmission case 1′ and water (chemical reaction) is blocked by impurities. This is because having done that, formation of the coating C is partially blocked, so partial changing of color to black does not occur.

Here, the coating C is not limited to being only a coating of magnesium hydroxide. For example, it is also possible to apply a black colored paint to the surface of the transmission case 1′.

In this case, it is possible to apply paint instead of the coating C of magnesium hydroxide, and also possible to further coat paint on top of the coating C of magnesium hydroxide.

It is preferable that the coating C be an item formed by chemical reaction such as magnesium hydroxide, or a paint that is coated as appropriate, etc., but the material is not limited as long as it can be made black. It can be said that an item formed by chemical reaction is preferable compared to a paint which is susceptible to heat (organic matter).

As shown in FIG. 4 (c), after the coating C is formed on the transmission case 1′, the mating surface region S1 and the bearing surface 11d are formed. In specific terms, by partially removing the coating C by machining, the mating surface region S1 and the bearing surface 11d are formed (in the drawing, see the dotted line).

Though omitted in the drawing, the mating surface region 10b (see FIG. 3 (b)) and the mating surface region 103a (see FIG. 3 (c)) are handled in the same manner as the mating surface region S1, and are formed by removing the coating C using machining.

Here, when the transmission case 1′ is immersed to form the coating C, though overall it becomes black, there is some variation in film thickness of the coating C. The same is true when applying water using a hose.

In the transmission case 1, the coating C is formed on the joining surface with the other constitutional elements of the automatic transmission case 4 (converter housing 2, reduction case 3, oil pan 5), and when there is variation in the thickness of this coating C, the assembly precision with the other constitutional elements is poor.

In light of that, from the perspective of ensuring assembly precision, after the coating of magnesium hydroxide is formed, it is preferable to implement machining on the joining surface with the other constitutional elements. At the regions in which machining is implemented, the shape precision (flatness, positioning) is higher than regions in which machining is not implemented, making it possible to ensure assembly precision.

By doing this, the surface of the transmission case 1′ is divided into a coated region R1 on which the coating C is formed, and an uncoated region R2 on which the coating C is removed (see FIG. 4 (c)). Because the uncoated region R2 is formed by machining, there is a higher flatness degree than the coated region R1.

### Uncoated Region R2

As shown in FIG. 4 (d), of the uncoated region R2, the through hole 11c is formed at a prescribed position in the region corresponding to the mating surface region S1 and the bearing surface 11d. The through hole 11c is formed by drilling, for example.

Also, of the uncoated region R2, at the mating surface region 10b (see FIG. 3 (b)), the bolt hole 10c is formed at a prescribed position. The bolt hole 10c is formed by drilling and tapping, for example.

Also, of the uncoated region R2, in the mating surface region 103a (see FIG. 3 (c)), the bolt hole 103c is formed at a prescribed position (see FIGS. 1 and 2). The bolt hole 103c is formed by drilling and tapping, for example. By doing this, the transmission case 1 is completed as a product (see FIG. 4 (d)).

After the through hole 11c, and the bolt holes 10c and 103c are formed, it is possible to also form the mating surface regions S1, 10b, and 103a. However, forming the through hole 11c and the bolt holes 10c and 103c after the mating surface regions S1, 10b, and 103a are formed allows higher degree of positioning of the through hole 11c and the bolt holes 10c and 103c.

FIG. 5 is a drawing for explaining the transmission case 1, and is an enlarged view of region A in FIG. 1.

The mating surface region S1 is a flat surface that is orthogonal to the rotation axis X. Also, the other end surface 20b of the converter housing 2 in the rotation axis X direction is also machined in the same manner as the mating surface region S1, and is a flat surface orthogonal to the rotation axis X.

When the other end surface 20b of the converter housing 2 and the mating surface region S1 of the transmission case 1 are matched, these are in contact with no gap across the entire surface. By doing this, leaking of the lubricating oil OL from between the transmission case 1 and the converter housing 2, etc., is prevented.

Here, the transmission case 1, the converter housing 2, the reduction case 3, and the oil pan 5 expand and contract according to changes in the ambient temperature.

This expansion and contraction is easily affected by temperature changes in the lubricating oil OL. In this case, the transmission case 1 and the converter housing 2, the reduction case 3, and the oil pan 5 are not evenly affected by temperature changes. For example, during transmission driving, the high temperature lubricating oil OL scraped up by the rotating body is mostly on the transmission case 1. Therefore, the transmission case 1 is the most greatly deformed. That being the case, there is concern for example that a gap will occur between the transmission case 1 and the converter housing 2, and the lubricating oil OL will leak from this gap. The same is also true between the transmission case 1 and the reduction case 3 or the oil pan 5.

With this embodiment, the mating surface region S1 of the transmission case 1 and the other end surface 20b of the converter housing 2 are formed with a high degree of flatness. For that reason, compared to cases when the coating C is not removed, there is less susceptibility to a gap being formed even if there is thermal deformation of the transmission case 1 and the converter housing 2, so it is possible to maintain an adhered state across the entire surface.

Thus, leaking of the lubricating oil OL from between the transmission case 1 and the converter housing 2 is more suitably prevented. The same is also true between the reduction case 3 and the oil pan 5.

Also, the bearing surface 11d is a flat surface that is orthogonal to the rotation axis X (center line Lx of the through hole 11c). The bearing surface 11d is formed by removing the coating C in the range of the inner diameter D2 that is slightly larger in diameter than the outer diameter D1 of a bolt flange B11 of the bolt B1 (D1<D2).

When the bolt B1 is tightened, the bolt flange B11 contacts along the entire surface of the bearing surface 11d. By doing this, the fastening holding force of the bolt B1 is received at the entire surface of the bearing surface 11d and is evenly distributed and stabilized.

Here, the coating C (magnesium hydroxide) is softer than the magnesium alloy, and is plastically deformed more easily (slackens easily). When the bearing surface 11d is not formed (when not removing the coating C), as a result of the fastening holding force of the bolt B1 being absorbed by plastic deformation (slackening) of the coating C, the fastening holding force of the bolt B1 decreases.

By forming the bearing surface 11d (removing the coating C), absorption of the fastening holding force of the bolt B1 by slackening of the coating C is prevented (improved resistance to slackening), and it is possible to prevent a decrease in the fastening holding force of the bolt B1.

When using only the bolt B1 without the bolt flange B11, it is sufficient to remove the coating C in the range of the inner diameter of a slightly larger diameter than the outer diameter D3 of a bolt head B10 of the bolt B1. This makes it possible to obtain the same effect as when using the abovementioned bolt flange B11.

Here, the uncoated region R2 of the transmission case 1 is the mating surface regions S1, 10b, and 103a, and the bearing surface 11d. At the uncoated region R2, this becomes the ground color of the magnesium alloy. Thus, though the uncoated region R2 is not black, the overall transmission case 1 has a regular color scheme.

Therefore, the delivery recipient recognizes the transmission case 1 as having that kind of design (color scheme). The delivery recipient does not judge this to be a transmission case with a mottled appearance as in the past, so does not have a disagreeable feeling.

As described above, the transmission case 1 (case) of the embodiment has the following configuration.

(1) The transmission case 1 (case) is made of a magnesium alloy.

The transmission case 1 has the lubricating oil OL (oil) housed inside.

The inner wall surface 101 of the transmission case 1 is used as the coated region R1 on which the coating C (black film) of magnesium hydroxide is formed.

When configured in this way, by having the delivery recipient recognize that this is that kind of design by intentionally forming the black film on the inner wall surface 101, it is possible to provide the transmission case 1 (case) that does not give a disagreeable feeling to the delivery recipient.

(2) The mating surface regions S1, 10b, and 103a in the transmission case 1 are used as the uncoated region R2 on which the coating C is not formed.

For example, to prevent leaking of lubricating oil, etc., the mating surface region S1 with the converter housing 2 in the transmission case 1 requires a high degree of flatness. Thus, removal of the coating C is necessary.

Using the configuration noted above, the coating C (black region) is removed only at the end part of the transmission case 1. Therefore, regularity is generated in the color scheme of the overall transmission case 1. Thus, the delivery recipient recognizes it to be such a design (color scheme), and is not given a disagreeable feeling.

(3) The bearing surface 11d (contact surface with the bearing surface of the fastening member) of the bolt B1 in the transmission case 1 is used as the uncoated region R2 on which the coating C is not formed.

To increase the fastening holding force of the bolt B1 and the resistance to slackening, etc., it is preferable that the bearing surface 11d be the uncoated region having a high degree of flatness.

Using the configuration noted above, the coating C (black portion) is removed in a regular pattern. Therefore, regularity is generated in the color scheme of the overall transmission case 1. Thus, the delivery recipient recognizes the item as having that kind of design, and is not given a disagreeable feeling.

(4) The side surface of the transmission case 1 through hole 11c and the bolt holes 10c and 103c are used as the uncoated region R2 on which the coating C is not formed.

For the assembly of the converter housing 2, the reduction case 3, and the oil pan 5 in the transmission case 1, it is necessary that the parts being assembled are formed with high shape precision. Therefore, it is preferable that the parts for assembly be uncoated regions.

When the parts for assembly configured as described above are uncoated regions, the coating C (black portion) is removed in a regular pattern. Thus, the delivery recipient recognizes this as having that kind of design, and is not given a disagreeable feeling.

(5) The transmission case 1 is placed in the vehicle.

The outer wall surface 102 of the transmission case 1 is used as a coated region R1 on which the coating C is formed.

During traveling of the vehicle, there are cases when water or contaminants, etc., from outside the vehicle infiltrate from outside into the engine room in which the transmission case 1 is housed. When that happens, due to the water, contaminants, etc., that infiltrated from outside, there is a risk that the outer wall surface 102 of the transmission case 1 will change color to black with a mottled appearance over time.

By using the configuration noted above, the outer wall surface 102 also becomes black by the coating C, so it is possible to prevent it being seen as having a mottled appearance.

### Modification Example

With the abovementioned embodiment, an example was shown of a case when the inner diameter D2 of the bearing surface 11d was formed to be slightly larger than the outer diameter D1 of the bolt flange B11 (D1<D2), but the invention is not limited to this mode.

For example, it is also possible to have a transmission case 1A for which the inner diameter D4 of the bearing surface 11d is smaller than the outer diameter D1 of the bolt flange B11 (see FIG. 6).

FIG. 6 is a drawing for explaining the transmission case 1A of the modification example, and shows a region correlating to region A in FIG. 1. For the modification example, only the parts that differ from the embodiment noted above are explained. The thickness of the coating C is shown exaggerated.

As shown in FIG. 6, the bearing surface 11d of the transmission case 1A of modification example 1 is formed by removing the coating C in the range of the inner diameter D4 that is a smaller diameter than the outer diameter D1 of the bolt flange B11 of the bolt B1 (D1>D4).

The bolt flange B11 is placed across the coated region R1 and the uncoated region R2 in the radial direction of the center line Lx of the through hole 11c.

At the outer circumference side of the bolt flange B11 in the radial direction of the center line Lx, the coating C is in a state sandwiched by the bolt flange B11 and the flange part 11 in the center line Lx direction.

In FIG. 6, the thickness of the coating C is shown exaggerated, but the actual thickness of coating C is extremely thin. Thus, when the bolt B1 is tightened, the inner circumference side of the bolt flange B11 is in contact with the uncoated region R2, and the outer circumference side of the bolt flange B11 is in contact with the coated region R1.

Here, as noted above, the coating C (magnesium hydroxide) is softer than the magnesium alloy. Thus, in the process of tightening the bolt B1, the coating C sandwiched by the bolt flange B11 and the flange part 11 is pressed out facing the center line Lx side (see the arrow in the drawing).

The pressed out coating C exhibits an effect as a sealing member. This makes it possible to suppress moisture, etc., from outside the transmission case 1A from infiltrating.

The inner circumference side of the bolt flange B11 is in contact with the uncoated region R2. By doing this, there is no absorption of the fastening holding force of the bolt B1 due to slackening of the coating C as described above and also no decrease in the fastening holding force of the bolt B1.

The transmission case 1A (case) of the modification example has the configuration below.

(6) The contact surface with the inner circumference side of the bolt flange B11 (inner periphery of the bearing surface) is used as the uncoated region R2, and the contact surface with the outer circumference side of the bolt flange B11 (outer periphery of the bearing surface) is used as the coated region R1.

By configuring in this way, it is possible to suppress infiltration of moisture to the uncoated region R2 that exists on the inner circumference side of the bolt flange B11 using the coated region R1 that exists on the outer circumference side of the bolt flange B11.

The fastening member is not limited to being a bolt. For example, it can also be the bearing surface of a screw, nut, etc., or of these combined with a washer (when using as standalone, the bearing surface of the standalone component, and when using a washer, the bearing surface of the washer).

Above, embodiments of the present invention were explained, but the present invention is not limited to only the modes shown in these embodiments. Changes can be made as appropriate within the scope of the technical ideas of the invention.

For example, as long as it is made of a magnesium alloy, the embodiments of the present invention can also be applied to the converter housing 2 and the reduction case 3. Also, the engine case that houses the engine, a motor case that houses a motor, and a reducer case that houses a decelerator that decelerates the output of the motor, etc., may also be any kind of item as long as it is a case in which the lubricating oil OL is housed. The case may be constituted from only one case, but it is also possible to configure by connecting two or more cases with bolts.

Also, in the connection of the transmission case 1 and the converter housing 2, when screwing the bolt B1 from the converter housing 2 side, a part correlating to the bearing surface 11d may be formed on the converter housing 2 side.

Also, for example the lubricating oil OL is lubricating oil or hydraulic oil, etc., of the drive members placed within the case (drive source (engine, motor, etc.) or power transmission member (transmission, decelerator, accelerator, gear alone, engagement element (clutch, etc.) etc.)), but the invention is not limited to this. There are also cases when the hydraulic oil and the lubricating oil are used together.

1. A case comprising:
a main body made of a magnesium alloy, and configured to house oil therein,
an inner wall surface of the main body is coated with a black film.

2. The case according to claim 1, wherein
the main body includes a mating surface region which is not coated with the black film.

3. The case according to claim 1, wherein
the main body includes a contact surface configured to contact a bearing surface of a fastening member, at least a part of the contact surface being not coated with the black film.

4. The case according to claim 3, wherein
a part of the contact surface configured to contact an inner periphery of the bearing surface is not coated with the black film, and a part of the contact surface configured to contact an outer periphery of the bearing surface is coated with the black film.

5. The case according to claim 1, wherein
the main body defines a screw hole with a side surface of the screw hole being not coated with the black film.

6. The case according to claim 1, wherein
the case is configured to be placed in a vehicle, and
an outer wall surface of the main body is coated with the black film.
